(19) United States
(12) Patent Application Publication
(10) Pub. No.: US 2025/0123115 A1
(43) Pub. Date: Apr. 17, 2025

(54) METHOD AND APPARATUS FOR PROVIDING MAP DATA FOR ROAD VEHICLE NAVIGATION, METHOD AND APPARATUS FOR OPERATING A ROAD VEHICLE, SYSTEM, MOTOR VEHICLE, AND COMPUTER PROGRAM

(71) Applicants: HYUNDAI MOTOR COMPANY, Seoul (KR); Kia Corporation, Seoul (KR)

(72) Inventors: Lukas Gaß, Mainz (DE); Dominik MATHEIS, Hanau (DE); Gerrit de GRAAG, Darmstadt (DE)

(73) Assignees: HYUNDAI MOTOR COMPANY, Seoul (KR); Kia Corporation, Seoul (KR)

(21) Appl. No.: 18/539,043

(22) Filed: Dec. 13, 2023

(30) Foreign Application Priority Data
Oct. 11, 2023 (DE) 102023127699.9

(51) Int. Cl. G01C 21/00; B60W 60/00

(52) U.S. Cl. CPC G01C 21/3807; B60W 60/00253; G01C 21/3844; G01C 21/3878; G01C 21/3885; B60W 2540/041; B60W 2556/40; B60W 2556/45

(57) ABSTRACT

Provided is a method for providing map data for road vehicle navigation. The method includes receiving sensor data including sensor acquisition of a road infrastructure. Furthermore, the method includes analyzing the sensor data to identify at least one ramp structure present in the road infrastructure and configured to potentially serve for a passenger as an entry and/or exit aid into or out of a road vehicle. Furthermore, the method includes generating the map data indicating the at least one ramp structure identified. Furthermore, there is provided method using those map data, and corresponding apparatuses, system, and computer program.

### CROSS-REFERENCE TO RELATED APPLICATION

The present application claims priority to German Patent Application No. 102023127699.9 filed on Oct. 11, 2023, the entire contents of which is incorporated herein for all purposes by this reference.

### BACKGROUND OF THE PRESENT DISCLOSURE

### Field of the Present Disclosure

The present disclosure relates to a method and an apparatus for providing map data for road vehicle navigation. Furthermore, the present disclosure relates to a method and an apparatus for operating a road vehicle. Furthermore, the present disclosure relates to a corresponding system, a motor vehicle, and a computer program (product).

### Description of Related Art

When a passenger enters and/or exits a road vehicle, there is usually a difference in height to be overcome because, for example, a lower edge of a door entry is elevated relative to a road surface. This may be a difficulty for the passenger, depending on the passenger's mobility and/or objects carried by the passenger. For example, in case of a mobility impairment, a rollator carried, a stroller carried, a wheelchair used, or the like, the difference in height may be a difficulty for the passenger.

To assist the passengers in entering and/or exiting the road vehicle, it may have an in-vehicle ramp, e.g., foldable ramp, a kneeling function suspension, a motor driven lift, or the like. These are intended to at least reduce the difference in height between the door entry and the road surface, thus facilitating entering and/or exiting the road vehicle. These in-vehicle solutions require packaging space and hardware implementation within the road vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Hence, there is a need to find solutions for improving assistance for entering and/or exiting a road vehicle.

According to a first aspect of the present disclosure, there is provided a method for providing map data for road vehicle navigation. The method includes receiving sensor data including sensor acquisition of a road infrastructure. Furthermore, the method includes analyzing the sensor data to identify at least one ramp structure present in the road infrastructure and configured to potentially serve for a passenger as an entry and/or exit aid into or out of a road vehicle. Furthermore, the method includes generating map data indicating the at least one ramp structure identified.

The provided method allows for assisting the passenger in entering and/or exiting the road vehicle, even without an in-vehicle and/or onboard entry and/or exit aid. Rather, the provided method relies on identifying the at least one ramp structure which is present in the road infrastructure anyway. Therefore, the at least one ramp structure may also be referred to as a natural ramp. It is noted, however, that the road vehicle may still include an in-vehicle and/or onboard entry and/or exit aid, which may be used in combination with the at least one ramp structure, e.g., for bridging any remaining difference in height or a gap between the at least one ramp structure and the road vehicle entry. Based on the map data indicating the at least one ramp structure, the road vehicle may be controlled either by a human driver or in a self-driving manner. In other words, the provided method allows for providing a legislation compliant, package space-efficient solution to enable passengers to enter and/or exit the road vehicle. This is done by the identification of natural ramps which have enough height to eliminate or at least minimize a gap between a lower edge portion of a door entry of the road vehicle. The identified ramps are saved in the map data, which may also be maintained and/or used a full fleet of road vehicles. The provided method allows for package space savings, e.g., for electric vehicle battery or the like, and cost savings for e.g., hardware implementation of an in-vehicle entry and/or exit aid. Also, there is no support of a driver of the road vehicle required, e.g., for unfolding an in-vehicle ramp or the like. Furthermore, the provided method allows for reducing entrance and/or exit times.

As used herein, the road infrastructure may be urban or rural environment. It may include any traffic route network and/or street system, including, for example, pedestrian walkways, traffic islands, bus stops, traffic regulation, or other development.

Furthermore, as used herein, the at least one ramp structure may be in a form of at least one of a bus stop, a pedestrian platform, a walkway, a traffic island, a curbstone, and a cargo loading port. However, in principle, any structure accessible to the respective passenger, i.e., publicly accessible, and suitable due to its configuration, such as its height, width, shape and/or form, accessibility, or the like, as an entry and/or exit aid may be considered as the at least one ramp structure. It is noted that the at least one ramp structure may already be a part of the road infrastructure and may therefore be referred to as a natural ramp. Merely by way of example, identifying the at least one ramp structure may be based on a target limit for e.g., partial and full barrier free steps and/or ramps. The present target limit may vary among different jurisdictions. For example, values may be taken from German norm DIN 18040, wherein similar guidance is available as EU norm EN 17210. Merely by way of example, a ramp height to the ground, e.g., road surface, walkway, etc., may be defined by a minimal height of 18 cm, wherein the height between ramp and vehicle door entry is relevant.

Furthermore, the at least one ramp structure may be identified based on the sensor data, e.g., based on data processing, image processing, or the like, considering, for example, detected features such as a bus stop sign, line markings, road surfaces markings, a tactile guidance system, topography, or the like.

Furthermore, the passenger may require an entry and/or exit aid for some reason. For example, the passenger may be mobility-impaired, include a wheelchair, may carry an object such as a stroller, a rollator, or the like. The at least one ramp structure may be used to eliminate or at least minimize the gap between the road surface and the road vehicle and/or the difference in height between the door entry of the road vehicle, e.g., between the lower edge portion of the door entry, of the road vehicle and the road surface.

Furthermore, the sensor data including sensor acquisition of the road infrastructure may, for example, be collected by use of at least one respective in-vehicle sensor of a number of road vehicles travelling in the road infrastructure. Alternatively or additionally, the sensor data may be collected by a passenger using a terminal device, such as smartphone, tablet computer, or the like. For example, the terminal device may include a depth camera, a plurality of cameras, a Light Detection and Ranging (LiDAR) sensor, or the like, configured to provide the sensor data. The sensor data may be used to identify the at least one ramp structure, e.g., in a courtyard driveway or a pedestal at the entrance of a doctor's office, etc., and may be processed by an application running on the terminal device, e.g., including geo-coordinates or by a remote computer, such as a server, cloud computer, or the like. If a result of the sensor data processing is positive, such as “ramp structure approachable/usable by road vehicle, e.g., PBV”, the terminal device may report the position together with a pick-up request, e.g., to a control center or the like, either only temporarily or as a new permanent stopping point. Also, the methods and apparatuses herein may distinguish between a private, personal and/or public ramp structure.

The provided method may be conducted by any computing means and may be a computer-implemented method. For example, the method may be at least partially conducted by an on-board computer of the motor vehicle. This may be, for example, an electronic control unit or the like. However, the method may also be at least partially conducted by a computer located remotely from the motor vehicle, such as a server, computer cloud, or the like. In the instant case, there may be a data link between the remote computer and the motor vehicle, such as a radio link or the like. For data exchange, e.g., for receiving the sensor data, one or more data interfaces, communication interfaces or the like may be provided. The method may also be conducted by a distributed computer system. The at least one parameter determined may, for example, be stored by the motor vehicle itself or received from the remote computer. For example, it may be stored in a suitable data source and/or may be determined in real time and/or during runtime.

It is understood that the term “vehicle” or “vehicular” or other similar term as used herein is inclusive of motor vehicles in general such as passenger vehicles including sports utility vehicles (SUV), buses, trucks, various commercial vehicles, public transportation road vehicles, shared transportation road vehicles, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles. Also, the vehicle may be an at least semi-automated vehicle, i.e., self-driving and/or (semi-) autonomous vehicle. The motor vehicle may also be referred to as ego vehicle.

Advantageous embodiments and improvements of the present disclosure are set out in the appended dependent claims.

According to an exemplary embodiment of the present disclosure, the method may further include providing the map data to at least one road vehicle. For example, may also be provided among a fleet of road vehicles. The respective road vehicle may be configured to process the map data, e.g., by processing circuitry or the like, to generate and/or provide route information to the at least one ramp structure therefrom. The map data and/or the route information may be used to navigate the road vehicle to the at least one ramp structure.

In an exemplary embodiment of the present disclosure, the at least one ramp structure may be indicated by its geographical location. For example, the indication may use coordinates, or the like.

According to an exemplary embodiment of the present disclosure, the at least one ramp structure may be indicated by its characteristics and/or configuration.

In an exemplary embodiment of the present disclosure, the characteristics of the at least one ramp structure may include at least one of a height of the ramp structure above a road surface, a width of the ramp structure, a shape and/or a form of the ramp structure, a height of the ramp structure relative to the respective road vehicle, and a distance and/or a gap between the ramp structure and the respective road vehicle.

The characteristics and/or configuration of the at least one ramp structure may include at least one of a height of the ramp structure above a road surface, a width of the ramp structure, a shape and/or a form of the ramp structure, a height of the ramp structure relative to the respective road vehicle, and a distance and/or a gap between the ramp structure and the respective road vehicle. Furthermore, accessibility of the at least one structure for specific passengers, such as the passenger, may be indicated in the map data. Furthermore, the map data may also indicate a suitability of the respective at least one ramp structure as an entry and/or exit aid for a specific type of road vehicle. In other words, the map data may be configured to allow a matching of the at least one structure and a specific type of road vehicle, as not every ramp structure may match every type of vehicle.

According to an exemplary embodiment of the present disclosure, the at least one ramp structure may be in a form of at least one of a bus stop, a pedestrian platform, a walkway, a traffic island, a curbstone, and a cargo loading port. However, in principle, any structure accessible to the respective passenger, i.e., publicly accessible, and suitable due to its configuration, such as its height, width, shape and/or form, or the like, as an entry and/or exit aid may be considered as the at least one ramp structure.

In an exemplary embodiment of the present disclosure, the method may further include checking the identified at least one ramp structure for its accessibility with a mobility aid, and/or a stroller, and indicating the determined accessibility in the map data. For example, the at least one ramp may be checked for obstacles which may block the way of a wheelchair, or the like, such as e.g., street lights, barriers, or the like. If an identified ramp structure has no proper accessibility, it may be disregarded from the map data 140. Otherwise, the determined accessibility of the identified ramp structure may be indicated in the map data, e.g., by a suitable label like “accessible by wheelchair and/or stroller”, or the like.

According to an exemplary embodiment of the present disclosure, the method may further comprise, prior to the analyzing of the sensor data, filtering of the sensor data by multi-access edge computing to reduce a number of ramp structure candidates. For example, to save bandwidth and/or increase data processing speed, the filter may be applied first, e.g., via multi-access edge computing. For instance, the sensor data, such as video, radio detection and ranging (RADAR) and/or LiDAR data may be cropped to e.g., max. 0.5 m level or any other suitable value above ground and/or road surface, or the like.

In an exemplary embodiment of the present disclosure, the at least one ramp structure may be indicated in the map data in a form of a point of interest and/or a map layer. A Point of Interest (POI) is a specific point location, or site, defined mainly by its geographical coordinates, namely longitude and latitude. The POI may also include the characteristics and/or configuration of the at least one ramp structure. The map layer may be understood as a mechanism used to display geographic datasets on maps. The geographic dataset may include the information of the at least one ramp structure as described herein.

According to an exemplary embodiment of the present disclosure, the map data may be generated and/or used for a public transport vehicle and/or a shared transport vehicle.

In an exemplary embodiment of the present disclosure, the method may further include receiving of response data indicating whether an actual entry position and/or exit position of the passenger into or out of the road vehicle complied with or was different from that indicated in the map data, and updating the map data based on the response data.

According to an exemplary embodiment of the present disclosure, the sensor acquisition and/or the at least one in-vehicle sensor may be based on at least one of a LiDAR sensor, a radar sensor, and a camera.

According to a second aspect, there is provided a method for operating a road vehicle. The method includes obtaining map data indicating at least one ramp structure present in a road infrastructure and configured to potentially serve for a passenger as an entry aid and/or exit aid into or out of the road vehicle. The method further includes receiving a request from a passenger for entering or exiting the road vehicle. Furthermore, the method includes determining, based on the map data and the received request, the at least one ramp structure as a targeted entry position or a targeted exit position. Furthermore, the method includes providing route information data indicating a route to the determined at least one ramp structure to the road vehicle.

The provided method allows for picking up and/or dropping off the passenger, i.e., setting up a common meeting point, thereby using the at least one ramp structure as entry aid and/or exit aid. The method may consider the current position of the road vehicle and of the passenger. Based on the map data, the at least one ramp structure may be determined as a meeting point between the road vehicle and the passenger. It may be determined e.g., the closest pick-up and/or drop off ramp structure. Also, the provided method may allow the passenger to choose between a plurality of possible ramp structures. The method also allows for controlling an autonomous vehicle based on the map data and the passenger's request.

The provided method may be conducted by any computing means and may be a computer-implemented method. For example, the method may be at least partially conducted by an on-board computer of the motor vehicle. This may be, for example, an electronic control unit or the like. However, the method may also be at least partially conducted by a computer located remotely from the motor vehicle, such as a server, computer cloud, or the like. In the instant case, there may be a data link between the remote computer and the motor vehicle, such as a radio link or the like. For data exchange, e.g., for receiving the sensor data, one or more data interfaces, communication interfaces or the like may be provided. The method may also be conducted by a distributed computer system. The at least one parameter determined may, for example, be stored by the motor vehicle itself or received from the remote computer. For example, it may be stored in a suitable data source and/or may be computed in real time and/or during runtime.

In an exemplary embodiment of the present disclosure, the at least one ramp structure may be determined based on a distance between the at least one ramp structure and the road vehicle and/or between the at least one ramp structure and the requesting passenger. For example, the closest ramp structure may be selected.

According to an exemplary embodiment of the present disclosure, if the request is for entering the road vehicle, the method may further include providing route information data indicating a route to the at least one ramp structure to the requesting passenger. The respective route information may be generated for the requesting passenger to provide a common meeting point at the at least one ramp structure to both the road vehicle and the requesting passenger. For example, the requesting passenger may receive the route information data via a terminal device and/or an application running thereon. It is understood that the term “terminal” or other similar term as used herein is inclusive of a user end device in general, such as a smartphone, smartwatch, handheld device, tablet computer, etc.

In an exemplary embodiment of the present disclosure, the method may further include receiving confirmation data indicating whether the passenger confirms the indicated at least one ramp structure to be used for entering the road vehicle. Optionally, the passenger request may only be fully considered if the passenger has provided the respective confirmation.

According to an exemplary embodiment of the present disclosure, the method may further include controlling the road vehicle to approach the at least one ramp structure based on the route information.

In an exemplary embodiment of the present disclosure, upon arrival of the road vehicle at the at least one ramp structure, the method may further include receiving detection data obtaining the at least one ramp structure by at least one in-vehicle sensor of the road vehicle, determining, based on the detection data, whether a position and/or orientation correction of the road vehicle relative to the at least one ramp structure is to be made for entering or exiting the road vehicle via the at least one ramp structure, and providing corresponding position and/or orientation correction data to the road vehicle based on the determination. In other words, the road vehicle may be aligned with the at least one ramp structure based on the detection data. It is noted that the apparatus may further receive passenger feedback, e.g., via the terminal device and/or application running thereon, indicating successful or unsuccessful entry and/or exit at the at least one ramp structure to update the map data on that basis.

According to a third aspect, there is provided an apparatus for providing map data for road vehicle navigation. The apparatus includes interface circuitry configured to receive sensor data including sensor acquisition of a road infrastructure collected by use of at least one respective in-vehicle sensor of a number of road vehicles travelling in the road infrastructure. Furthermore, the apparatus includes processing circuitry configured to analyze the sensor data to identify at least one ramp structure present in the road infrastructure and configured to potentially serve for a passenger as an entry and/or exit aid into or out of a road vehicle, and generate map data indicating the at least one ramp structure identified.

The apparatus may be configured to carry out or implement the method according to the first aspect, so reference is made to the first aspect.

According to a fourth aspect, there is provided an apparatus for operating a road vehicle. The apparatus includes interface circuitry configured to receive request data from a passenger for entering or exiting the road vehicle. The apparatus further includes processing circuitry configured to obtain map data indicating at least one ramp structure present in a road infrastructure and to potentially serve for a passenger as an entry aid and/or exit aid into or out of the road vehicle. The processing circuitry is further configured to determine, based on the map data and the received request data, the at least one ramp structure as a targeted entry position or a targeted exit position, and provide route information data indicating a route to the at least one ramp structure to the road vehicle.

The apparatus may be configured to carry out or implement the method according to the second aspect, so reference is made to the second aspect.

According to various aspects of the present disclosure, there is provided a system, including an apparatus according to the third aspect and an apparatus according to the fourth aspect.

According to various aspects of the present disclosure, there is provided a motor vehicle including an apparatus according to the fourth aspect.

According to various aspects of the present disclosure, there is provided a computer program including instructions which, when the program is executed by a computer, cause the computer to carry out the method according to the first aspect, and/or to carry out the method according to the second aspect. There may be a computer-readable medium including the computer program.

The present disclosure will be explained in greater detail with reference to exemplary embodiments depicted in the drawings as appended.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates schematically an exemplary application scenario for embodiments of the present disclosure.

FIG. 2 illustrates schematically an apparatus for providing map data for road vehicle navigation, according to an exemplary embodiment of the present disclosure.

FIG. 3A, FIG. 3B, FIG. 3C, FIG. 3D and FIG. 3E illustrate exemplary identification parameters, characteristics and/or configurations associated with identification of at least one ramp structure based on the received sensor data.

FIG. 4 illustrates schematically an exemplary method for generating sensor data obtaining a road infrastructure.

FIG. 5 illustrates schematically an apparatus for operating a road vehicle, according to an exemplary embodiment of the present disclosure.

FIG. 6 illustrates in a flowchart a method a method for providing map data.

FIG. 7 illustrates in a flow chart a method 500 for operating a road vehicle.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

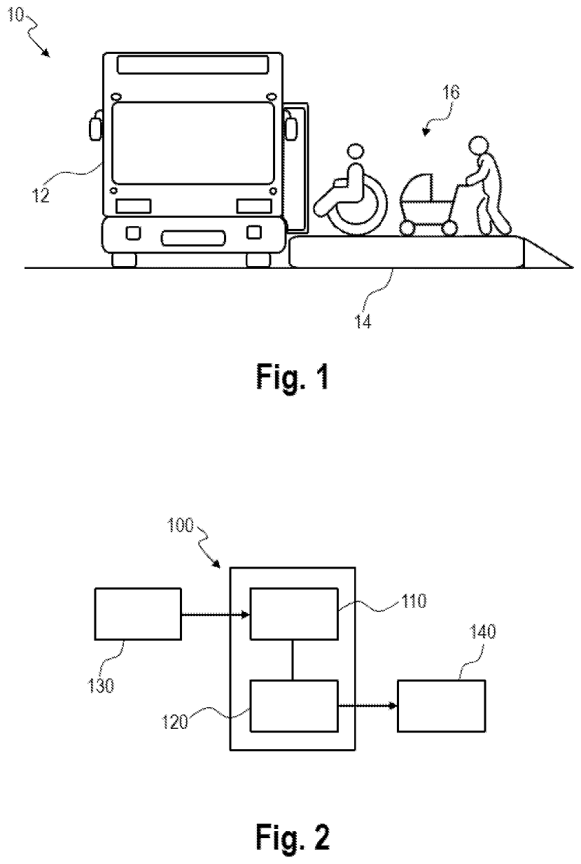

FIG. 1 illustrates schematically an exemplary application scenario for embodiments of the present disclosure. FIG. 1 illustrates a road infrastructure 10 which is used by a road vehicle 12 for travelling. Due to the road vehicle's 12 design, there is a gap or a difference in height between the road vehicle, e.g., a lower edge portion of a door entry of the road vehicle 12, and a road surface which may be overcome by a passenger 16 when entering and/or exiting the road vehicle 12.

However, in the road infrastructure 10 is at least one ramp structure 14 present which is configured to, at least potentially, serve for the passenger 16 as an entry and/or exit aid for entering and/or exiting the road vehicle 12. For example, the at least one ramp structure 14 may be in a form of at least one of a bus stop, a pedestrian platform, a walkway, a traffic island, a curbstone, and a cargo loading port. However, in principle, any structure accessible to the respective passenger 16, i.e., publicly accessible, and suitable due to its configuration, such as its height, width, shape and/or form, or the like, as an entry and/or exit aid may be considered as the at least one ramp structure 14. It is noted that the at least one ramp structure 14 may already be a portion of the road infrastructure 10 and may therefore be referred to as a natural ramp.

The passenger 16 may require an entry and/or exit aid for some reason. Merely by way of example, FIG. 1 illustrates a wheelchair and a stroller carried by a person, both of which may be associated with or may be an example of the passenger 16. Accordingly, the passenger 16 may, for example, be mobility-impaired, have a wheelchair, may carry an object such as the stroller, a rollator, or the like, etc. The at least one ramp structure 14 may be used to eliminate or at least minimize the gap between the road surface and the road vehicle 12 and/or the difference in height between the door entry of the road vehicle 12, e.g., between the lower edge portion of the door entry, of the road vehicle 12 and the road surface.

As disclosed herein, map data 140 (see e.g., FIG. 2), e.g., digital map data, is generated, provided and/or used indicating the at least one ramp structure 14 for road vehicle navigation purposes, i.e., for map-based navigating of any road vehicle such as the road vehicle 12. For example, the map data 140 may indicate the geographical location of the at least one ramp structure 14. Furthermore, by way of example, the map data 140 may indicate characteristics and/or a configuration of the respective at least one ramp structure 14. Furthermore, by way of example, the at least one ramp structure 14 may be indicated in the map data 140 in a form of a point of interest (POI) and/or a map layer.

The map data 140 may be used for navigating a public transport vehicle or a shared transport vehicle, such as a bus, a minibus, a van, a vehicle, or the like, wherein the type of vehicle is not limited herein. Accordingly, the road vehicle 12 may be any road vehicle capable for passenger transportation. Furthermore, the road vehicle 12 may be a motor vehicle. The road vehicle 12 may be operated manually, i.e., operated by a human driver, or may be configured for at least semi-self-driving, i.e., may be an at least partially self-driving vehicle. Accordingly, the map data 140 may be provided to the human driver or may be used to automatically navigate the self-driving vehicle, for providing route information for approaching the at least one ramp structure 14.

FIG. 2 illustrates schematically an apparatus 100 for providing map data 140 for road vehicle navigation. The apparatus 100 includes interface circuitry 110 and processing circuitry 120 such as a processor, coupled to each other.

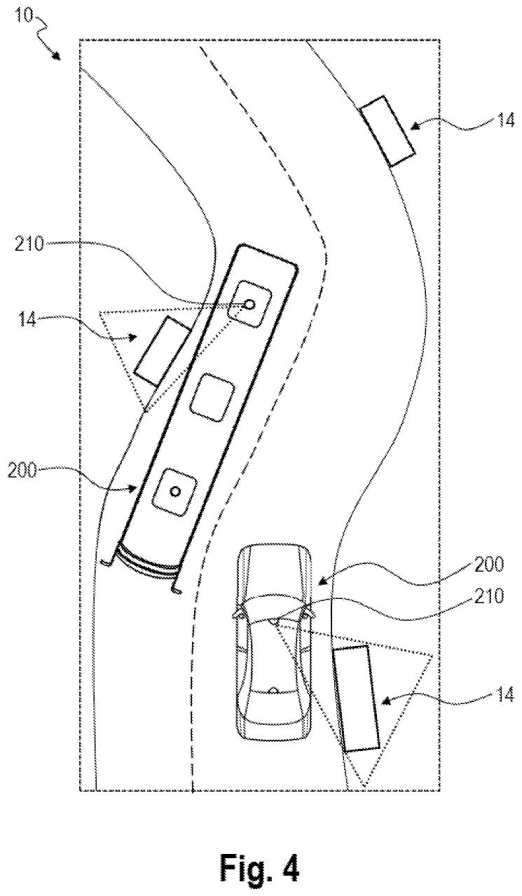

The apparatus 100 may be applied to a road vehicle, such as e.g., the road vehicle 12 (or road vehicle 200 shown in FIG. 4), or more generally to a motor vehicle. For example, the apparatus 100 may be implemented in an electronic control module or the like of the respective vehicle. Alternatively, the apparatus 100 may be applied to a central computing system, such as a server, a computing cloud, or the like. Also, the apparatus 100 may be implemented as a distributed computer system.

The interface circuitry 110 is configured to receive sensor data 130 including sensor acquisition of a road infrastructure, e.g., the above-mentioned road infrastructure 10, collected by using, for example, at least one respective in-vehicle sensor 210 (see e.g., FIG. 4) of a number of road vehicles 200 (see e.g., FIG. 4) travelling in the road infrastructure 10. It is noted that, optionally, sensor data from a plurality of vehicles may be processed, also together, to make use of swarm intelligence. Alternatively or additionally, the sensor data 130 may be collected by a passenger using a terminal device, such as smartphone, tablet computer, or the like. For example, the terminal device may include a depth camera, a plurality of cameras, a LiDAR sensor, or the like, configured to provide the sensor data 130. The sensor data 130 may be used to identify the at least one ramp structure 14, e.g., in a courtyard driveway or a pedestal at the entrance of a doctor's office, etc., present in the road infrastructure 10, and may be processed by an application running on the terminal device, e.g., including geo-coordinates or by a remote computer, such as a server, cloud computer, or the like. If a result of the sensor data 130 processing is positive, such as “ramp structure approachable/usable by road vehicle, e.g., PBV”, the terminal device may report the position together with a pick-up request, e.g., to a control center or the like, either only temporarily or as a new permanent stopping point. Also, the methods and apparatuses herein may distinguish between a private, personal and/or public ramp structure.

For example, the sensor acquisition and/or the at least one in-vehicle sensor may be based on at least one of a Light Detection and Ranging (LiDAR) sensor, a radio detection and ranging (RADAR) sensor, a camera, an ultrasonic sensor, or any other sensor which is configured to obtain the road infrastructure 10. It is also conceivable that existing navigation map data is analyzed to identify the at least one ramp structure 14, and as noted above, it is also conceivable that the sensor acquisition may be provided by the terminal device of the passenger 16.

The processing circuitry 120 is configured to analyze the sensor data 140 to identify at least one ramp structure 14 present in the road infrastructure 10, wherein the at least one ramp structure is configured to potentially serve for a passenger. e.g., passenger 16 (see e.g., FIG. 1), as an entry and/or exit aid into or out of a road vehicle, e.g., road vehicle 12. Furthermore, the processing circuitry 120 is configured to generate map data, e.g., the above-mentioned map data 140, indicating the at least one ramp structure 14 identified.

The map data 140 may be provided to at least one road vehicle, e.g., to the road vehicle 12 and/or to any other road vehicle. The map data 140 may also be provided among a fleet of road vehicles. The respective road vehicle may be configured to process the map data 140, e.g., by processing circuitry or the like, to generate and/or provide route information to the at least one ramp structure 14 therefrom. The map data 140 and/or the route information may be used to navigate the road vehicle, e.g., the road vehicle 12, to the at least one ramp structure 14.

As mentioned above, the at least one ramp structure 14 may be indicated by, for example, its geographical location, its characteristics and/or configuration, or the like. The characteristics and/or configuration of the at least one ramp structure 14 may include at least one of a height of the ramp structure above a road surface, a width of the ramp structure, a shape and/or a form of the ramp structure, a height of the ramp structure relative to the respective road vehicle, and a distance and/or a gap between the ramp structure 14 and the respective road vehicle. Furthermore, accessibility of the at least one structure 14 for passengers, such as the passenger 16, may be indicated in the map data 140. Furthermore, the map data 140 may also indicate a suitability of the respective at least one ramp structure 14 as an entry and/or exit aid for a specific type of road vehicle. In other words, the map data 140 may be configured to allow a matching of the at least one structure 14 and a specific type of road vehicle, as not every ramp structure 14 may match every type of vehicle. As mentioned above, the at least one ramp structure 14 may be indicated in the map data 140 in a form of a point of interest (POI) and/or a map layer.

Furthermore, by way of example, the apparatus 100, and particularly the processing circuitry 120, may be configured to check, based on the sensor data 130, the identified at least one ramp structure 14 for its accessibility with a mobility aid and/or a stroller. For example, the at least one ramp 14 may be checked for obstacles which may block the way of a wheelchair, or the like. If an identified ramp structure has no proper accessibility, it may be disregarded from the map data 140. Otherwise, the determined accessibility of the identified ramp structure may be indicated in the map data, e.g., by a suitable label like “accessible by wheelchair and/or stroller”, or the like.

Furthermore, by way of example, the apparatus 100, and particularly the processing circuitry 120, may be further configured to, prior to the analyzing of the sensor data 130, filter the sensor data 130 by multi-access edge computing to reduce a number of ramp structure candidates. To save bandwidth and/or increase data processing speed, the filter may be applied first, e.g., via multi-access edge computing. For instance, the sensor data 130, such as video, radar and/or LiDAR data may be cropped to e.g., max. 0.5 m level above ground and/or road surface, or the like.

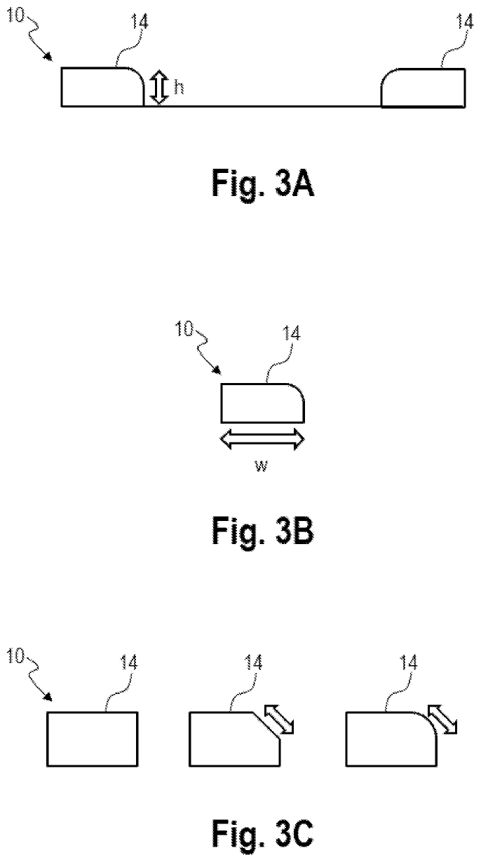

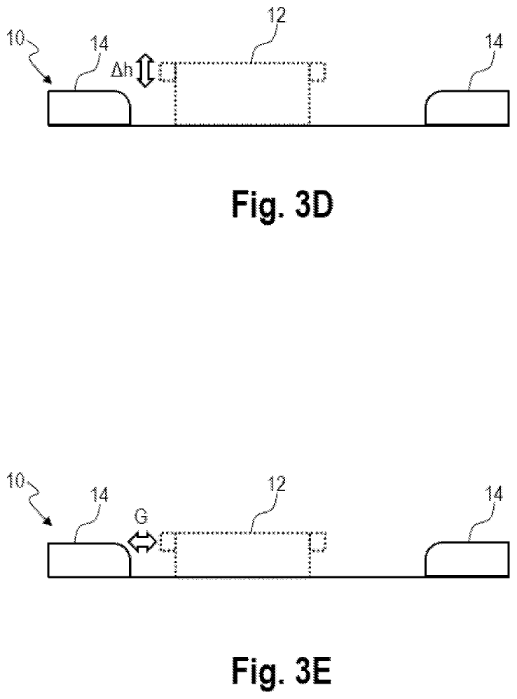

FIG. 3A, FIG. 3B, FIG. 3C, FIG. 3D and FIG. 3E illustrate exemplary identification parameters and/or exemplary characteristics and/or configurations associated with identification of the at least one ramp structure 14 based on the received sensor data 130. For example, the above apparatus 100 may use one or more of those identification parameters and/or characteristics and/or configurations of the at least one ramp structure 14 to identify the latter based on the sensor data 130.

According to FIG. 3A, one parameter and/or characteristic and/or configuration used for identification may be a height h of the at least one ramp structure 14. For example, the identification may be based on determining the height h of an upper edge portion of the at least one ramp structure 14 above a road surface with a certain minimum value, such as in the centimeter range, such as, for example, 10, 11, 12, 13, 14, . . . , 18, 19, . . . , or more cm.

Furthermore, according to FIG. 3B, one parameter and/or characteristic and/or configuration used for identification may be a width w of the at least one ramp structure 14. For example, the identification may be based on determining the width w of the at least one ramp structure 14, e.g., parallel to the road, with a certain minimum value, such as in the centimeter range or meter range, such as in the centimeter range or meter range, such as, for example, 60 cm or more, 1 m or more, or the like.

According to FIG. 3C, one parameter and/or characteristic and/or configuration used for identification may be a shape and/or a form of the at least one ramp structure 14. For example, the identification may be based on determining the shape and/or form of the at least one ramp structure 14 including no significant edges or curves facing the road and/or the road vehicle 12. For example, a maximum radius of the edge acceptable may be in the centimeter range, such as, for example, 2 cm or the like. Generally, an angular form and/or shape may be exemplary.

Furthermore, according to FIG. 3D, one parameter and/or characteristic and/or configuration used for identification may be a difference in height Δh between the at least one ramp structure 14 and a door entry of the road vehicle 12, e.g., between a lower edge portion of the door entry and an upper edge portion of the at least one ramp structure 14. The height of the road vehicle 12, and particularly of its door entry, may be known from, e.g., specification of the road vehicle 12. For example, a difference in height Δh in the centimeter range may be acceptable. Merely exemplarily, a difference in height Δh of about 5 cm may be considered ideal, and a difference in height Δh up to 10 cm may be acceptable, wherein the present value may depend on the type of road vehicle, a requirement of the passenger 16, or other feasible parameters related thereto.

According to FIG. 3E, one parameter and/or characteristic and/or configuration used for identification may be a gap G between the at least one ramp structure 14 and a door entry of the road vehicle 12. Merely exemplarily, a gap G of about 5 cm may be considered ideal, and a difference in height Δh up to 10 cm may be acceptable, wherein the present value may depend on the type of road vehicle, a requirement of the passenger 16, or other feasible parameters related thereto.

FIG. 4 illustrates schematically an exemplary method for generating the above-mentioned sensor data 130, based on which the map data 140 is generated as described above.

In FIG. 4, the road infrastructure 10 is again illustrated, in which the at least one ramp structure 14 is present. Merely for illustrative purposes, FIG. 4 shows exemplarily three ramp structures 14, wherein the number of ramp structures 14 may be any integer greater than or equal to 1.

At least one road vehicle 200 utilizes the road infrastructure 10 for travelling, in which the at least one ramp structure 14 is present. Merely for illustrative purposes, FIG. 4 shows exemplarily two road vehicles 200, wherein the number of ramp structures 14 may be any integer greater than or equal to 1. The at least one road vehicle 200 includes at least one in-vehicle sensor 210 configured to obtain the road infrastructure 10 at least in part. In other words, the at least one road vehicle 200, or multiply, or even a fleet of road vehicles 200, may collect sensor acquisition data of the road infrastructure 10. When the road infrastructure 10 includes the at least one ramp structure 14, the sensor acquisition may also include the at least one ramp structure 14. The sensor acquisition and/or the at least one in-vehicle sensor 210 may be based on at least one of a LiDAR sensor, a radar sensor, a camera, or any other sensor which is configured to obtain the road infrastructure 10. The present collected sensor acquisition may be used to generate the sensor data 130 to be processed to identify the at least one ramp structure 14 therefrom. It is noted that the road vehicle 200 may also include or may be identical to the above-mentioned road vehicle 14 or may be any other road vehicle travelling in the road infrastructure 10 and participating in the data collection and/or sensor acquisition.

The collected data, i.e., the sensor acquisition of the road infrastructure 10, may be provided by the at least one road vehicle 200 to the above-mentioned apparatus 100 as the sensor data 130 to generate the above-mentioned map data 140 on that basis. As mentioned above, the corresponding data processing may be conducted centralized, by e.g., a server, a computing cloud or the like, or decentralized by the road vehicle 200 itself or any other suitable computing means. Also, the data processing may be conducted in a distributed manner.

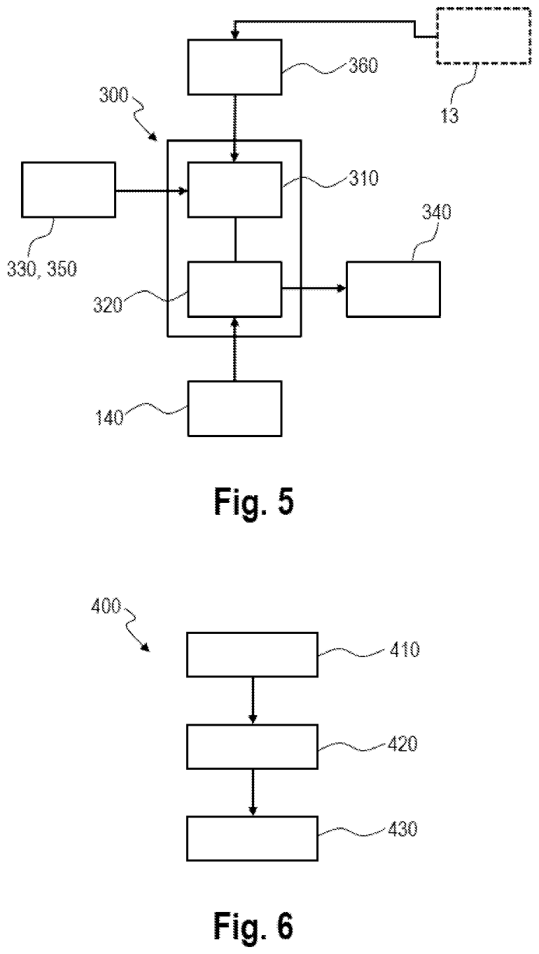

FIG. 5 illustrates schematically an apparatus 300 for operating a road vehicle, such as the above-mentioned road vehicle 12. The apparatus 300 may be used to navigate the road vehicle 12 and/or may provide route information to the road vehicle 12. The apparatus 300 may be applied to a road vehicle, such as e.g., the road vehicle 12, or generally to a motor vehicle. The apparatus 300 may, for example, be implemented in an electronic control module or the like of the road vehicle.

The apparatus 300 includes interface circuitry 310 and processing circuitry 320 such as a processor, coupled to each other.

The interface circuitry 310 is configured to receive request data 330 from a passenger, e.g., the passenger 16, for entering or exiting the road vehicle, e.g., the road vehicle 12. For example, if the passenger's request is for entering the road vehicle 12, the request data 330 may be received from a terminal device carried by the passenger and running, for example, an application via which the passenger may generate and send the request data 330 to the apparatus 300, optionally via a server, computing cloud, or the like. If the passenger rides in the vehicle, the passenger's request may be for exiting the road vehicle 12. In the instant case, the passenger may also use the above terminal device and/or application to send the request data 330. Alternatively, the request data 330 may be generated within the road vehicle 12 upon, for example, manual actuation of a corresponding input device, such as a button or the like, in the road vehicle 12. Furthermore, by way of example, the request data 330 may be configured to indicate any special requirement of the requesting passenger in terms of entering and/or exiting the road vehicle 12. For example, the request data 330 may indicate that the requesting passenger is mobility-impaired, has a wheelchair, carries an object like a mobility aid and/or a stroller, or the like.

The processing circuitry 320 is configured to obtain map data, e.g., the above-mentioned map data 140, indicating at least one ramp structure, e.g., the at least one ramp structure 14, present in the road infrastructure 10 and configured to potentially serve for a passenger as an entry aid and/or exit aid into or out of the road vehicle, e.g., the road vehicle 12. For example, the map data 140 may be stored in a memory of the apparatus 300 coupled to the processing circuitry 320, or may be received via the interface circuitry 310, and/or via e.g., a data connection, such as a vehicle-to-vehicle, a vehicle-to-everything, etc. connection.

Furthermore, the processing circuitry 320 is configured to determine, based on the map data 140 and the received request data 330, the at least one ramp structure 14 as a targeted entry position or a targeted exit position into or out of the road vehicle 12. Furthermore, the apparatus 300 is configured to generate and/or provide route information data 340 indicating a route to the at least one ramp structure 14 to the road vehicle 12.

For example, the route information data 340 may be provided to a human driver of the road vehicle 12 or may be used to control the road vehicle 12 in an at least semi-autonomous driving and/or partially self-driving manner. In the latter case, the route information data 340 may be used to control the road vehicle 12 to approach the at least one ramp structure 14 based on the route information data 340.

It is noted that, in case that the passenger's request is for entering the road vehicle 12, the route information data 340 may also be provided to the requesting passenger 16, wherein the respective route information may be generated for the requesting passenger 16, to provide a common meeting point at the at least one ramp structure 14 to both the road vehicle 12 and the requesting passenger 16. For example, the requesting passenger 16 may receive the route information data 340 via the above-mentioned terminal device and/or the application running thereon. Also, the apparatus 300, via the interface circuitry 310, may be configured to receive confirmation data 350 from the passenger 16 indicating whether the passenger confirms that the indicated at least one ramp structure 14 will be used for entering the road vehicle 12. Optionally, the passenger request may only be considered if the passenger 16 has provided the respective confirmation.

Furthermore, if the passenger 16 has arrived at the at least one ramp structure 14, i.e., the meeting point with the road vehicle 12, the passenger 16 may inform the road vehicle 12 thereabout, if the road vehicle 12 is a self-driving vehicle. Again, for the present purpose, the terminal device of the passenger and/or the application running thereon may provide respective data to the apparatus 300, e.g., via the interface circuitry 330.

Furthermore, by way of example the at least one ramp structure 14 may be determined based on a geographical and/or temporal distance between the at least one ramp structure 14 and the road vehicle 12, and/or between the at least one ramp structure 14 and the passenger 16. For example, one or more ramp structures 14 may be provided within walking distance for the passenger and/or within an operating area of the road vehicle 12. Of these, one or more may be suitable to meet the passenger's request and/or may be compatible with the passenger vehicle 12. The processing circuitry 320 may be configured to select the most suitable ramp structure 14 to be approached on that basis, e.g., based on the distance(s) thereto, the height, the width, and/or the accessibility, etc.

Furthermore, upon arrival of the road vehicle 12 at the at least one ramp structure 14, the apparatus 300 may be configured to receive detection data 360 obtaining the at least one ramp structure 14 by at least one in-vehicle sensor 13 of the road vehicle 12. Furthermore, the apparatus 300 may be configured to determine, based on the detection data 360, whether a position and/or orientation correction of the road vehicle relative to the at least one ramp structure is to be made for entering or exiting the road vehicle via the at least one ramp structure. Furthermore, the apparatus 300 may be configured to generate and/or provide corresponding position and/or orientation correction data to the road vehicle based on the determination. In other words, the road vehicle 12 may be aligned with the at least one ramp structure 14 based on the detection data 360. It is noted that the apparatus 300 may further receive passenger feedback, e.g., via the terminal device and/or application running thereon, indicating successful or unsuccessful entry and/or exit at the at least one ramp structure 14 to update the map data 140 on that basis.

FIG. 6 illustrates in a flowchart a method 400 a method for providing map data, e.g., the above map data 140, for road vehicle navigation. The method 400 may be applied to or may be conducted by e.g., the above apparatus 100. It may be implemented by instructions, e.g., a computer program, and stored on a computer-readable medium. That is, the method 400 may be computer-implemented.

The method includes receiving 410 sensor data, e.g., sensor data 130, including sensor acquisition of a road infrastructure, e.g., road infrastructure 10, collected by use of at least one respective in-vehicle sensor, e.g., in-vehicle sensor 210, of a number of road vehicles, e.g., road vehicle 200 and/or 12, travelling in the road infrastructure. Furthermore, the method includes analyzing 420 the sensor data to identify at least one ramp structure, e.g., the above at least one ramp structure 14, present in the road infrastructure and configured to potentially serve for a passenger, e.g., the above passenger 16, as an entry and/or exit aid into or out of a road vehicle, e.g., road vehicle 12. Furthermore, the method 400 includes generating 430 map data, e.g., map data 140, indicating the at least one ramp structure identified.

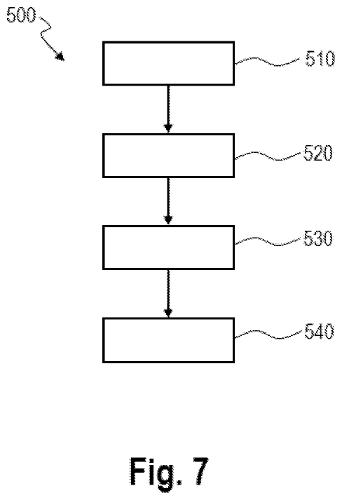

FIG. 7 illustrates in a flow chart a method 500 for operating a road vehicle, e.g., the above road vehicle 12. The method 500 may be applied to or may be conducted by e.g., the above apparatus 300. It may be implemented by instructions, e.g., a computer program, and stored on a computer-readable medium. That is, the method 400 may be computer-implemented.

The method 500 includes obtaining 510 map data, e.g., the above map data 140, indicating at least one ramp structure, e.g., the above at least one ramp structure 14, present in a road infrastructure, e.g., the above road infrastructure 10, and configured to potentially serve for a passenger, e.g., the above passenger 16, as an entry aid and/or exit aid into or out of the road vehicle. Furthermore, the method includes receiving 520 a request from a passenger for entering or exiting the road vehicle. Furthermore, the method 500 includes determining 530, based on the map data and the received request, the at least one ramp structure as a targeted entry position or a targeted exit position. Furthermore, the method 500 includes providing 540 route information data indicating a route to the determined at least one ramp structure to the road vehicle.

The apparatus 100 or 300 may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the apparatus 100 or 300 may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for providing map data for vehicle navigation, the method comprising:
receiving, by a processing circuitry, sensor data including sensor acquisition of a road infrastructure,
analyzing, by the processing circuitry, the sensor data to identify at least one ramp structure present in the road infrastructure to serve for a passenger as an entry and/or exit aid into or out of a vehicle, and
generating, by the processing circuitry, the map data indicating the at least one ramp structure identified.

2. The method of claim 1, further including providing, by the processing circuitry, the map data to at least one vehicle.

3. The method of claim 1, wherein the at least one ramp structure is indicated by a geographical location of the at least one ramp structure.

4. The method of claim 1, wherein the at least one ramp structure is indicated by characteristics and/or configuration of the at least one ramp structure.

5. The method of claim 4, wherein the characteristics and/or configuration of the at least one ramp structure includes at least one of a height of the at least one ramp structure above a road surface, a width of the at least one ramp structure, a shape and/or a form of the at least one ramp structure, a height of the at least one ramp structure relative to a respective vehicle, and a distance and/or a gap between the at least one ramp structure and the respective vehicle.

6. The method of claim 1, wherein the at least one ramp structure is at least one of a bus stop, a pedestrian platform, a walkway, a traffic island, a curbstone, and a cargo loading port.

7. The method of claim 1, further including:
checking, by the processing circuitry, the identified at least one ramp structure for accessibility of the at least one ramp structure with a mobility aid and/or a stroller, and
indicating, by the processing circuitry, the determined accessibility in the map data.

8. The method of claim 1, wherein the at least one ramp structure is indicated in the map data in a form of a point of interest and/or a map layer.

9. The method of claim 1, wherein the map data is generated for a public transport vehicle and/or a shared transport vehicle.

10. The method of claim 1, wherein the sensor acquisition is performed by use of at least one of a Light Detection and Ranging (LiDAR) sensor, a radio detection and ranging (RADAR) sensor, an ultrasonic sensor, and a camera.

11. A method for operating a vehicle, the method comprising:
obtaining, by a processing circuitry, map data indicating at least one ramp structure present in a road infrastructure to serve for a passenger as an entry aid and/or exit aid into or out of the vehicle,
receiving, by the processing circuitry, a request from a passenger for entering or exiting the vehicle,
determining, by the processing circuitry, the at least one ramp structure as a targeted entry position or a targeted exit position, based on the map data and the received request, and
providing, by the processing circuitry, route information data indicating a route to the at least one ramp structure, to the vehicle.

12. The method of claim 11, wherein in response that the request is for entering the vehicle, the method further includes:
providing, by the processing circuitry, the route information data indicating the route to the at least one ramp structure to the requesting passenger.

13. The method of claim 12, further including:
receiving, by the processing circuitry, confirmation data indicating whether the passenger confirms the indicated at least one ramp structure to be used for entering the vehicle.

14. The method of claim 11, further including:
controlling, by the processing circuitry, the vehicle to approach the at least one ramp structure based on the route information data.

15. The method of claim 11, wherein upon arrival of the vehicle at the at least one ramp structure, the method further includes:
detecting, by the processing circuitry, the at least one ramp structure by use of at least one in-vehicle sensor of the vehicle,
determining, by the processing circuitry, based on the detecting, whether a position and/or orientation correction of the vehicle relative to the at least one ramp structure is to be made for entering or exiting the vehicle via the at least one ramp structure, and
providing, by the processing circuitry, position and/or orientation correction data to the vehicle based on the determining.

16. An apparatus for providing map data for vehicle navigation, the apparatus comprising:
an interface circuitry configured to receive sensor data including sensor acquisition of a road infrastructure, and
a processing circuitry operatively connected to the interface circuitry and configured to:
analyze the sensor data to identify at least one ramp structure present in the road infrastructure to serve for a passenger as an entry and/or exit aid into or out of a vehicle, and
generate map data indicating the at least one ramp structure identified.

17. An apparatus for operating a vehicle, the apparatus comprising:
an interface circuitry configured to receive a request from a passenger for entering or exiting the vehicle,
a processing circuitry configured to:
obtain map data indicating at least one ramp structure present in a road infrastructure to serve for a passenger as an entry aid and/or exit aid into or out of the vehicle, and
determine, based on the map data and the received request, the at least one ramp structure as a targeted entry position or a targeted exit position, and
provide route information data indicating a route to the at least one ramp structure to the vehicle.

18. A system, comprising the apparatus of claim 16.

19. A system, comprising the apparatus of claim 17.

20. A motor vehicle, comprising the apparatus of claim 17.

21. A computer program comprising instructions wherein the program is executed by a computer to cause the computer to carry out the method of claim 1.

22. A computer program comprising instructions wherein the program is executed by a computer to cause the computer to carry out the method of claim 11.
